(19) United States
(12) Patent Application Publication
(10) Pub. No.: US 2018/0358025 A1
(43) Pub. Date: Dec. 13, 2018

(54) METHOD AND APPARATUS FOR AUDIO OBJECT CODING BASED ON INFORMED SOURCE SEPARATION

(71) Applicant: THOMSON Licensing, Issy-les-Moulineaux (FR)

(72) Inventors: Quang Khanh Ngoc DUONG, Rennes (FR); Alexey OZEROV, Rennes (FR)

(21) Appl. No.: 15/780,591

(22) PCT Filed: Nov. 25, 2016
(86) PCT No.: PCT/EP2016/078886

§ 371 Date: May 31, 2018

(30) Foreign Application Priority Data
Dec. 1, 2015 (EP) 15306899.4

(51) Int. Cl. G10L 19/008; G10L 19/06

(52) U.S. Cl. CPC G10L 19/008; G10L 19/06

(57) ABSTRACT

To represent and recover the constituent sources present in an audio mixture, informed source separation techniques are used. In particular, a universal spectral model (USM) is used to obtain a sparse time activation matrix for an individual audio source in the audio mixture. The indices of non-zero groups in the time activation matrix are encoded as the side information into a bitstream. The non-zero coefficients of the time activation matrix may also be encoded into the bitstream. At the decoder side, when the coefficients of the time activation matrix are included in the bitstream, the matrix can be decoded from the bitstream. Otherwise, the time activation matrix can be estimated from the audio mixture, the non-zero indices included in the bitstream, and the USM model. Given the time activation matrix, the constituent audio sources can be recovered based on the audio mixture and the USM model.

### TECHNICAL FIELD

This invention relates to a method and an apparatus for audio encoding and decoding, and more particularly, to a method and an apparatus for audio object encoding and decoding based on informed source separation.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Recovering constituent sound sources from their single-channel or multichannel mixtures is useful in some applications, for example, muting the voice signal in karaoke, spatial audio rendering (i.e., to have 3D sound effect), and audio post-production (i.e., adding effects on a specific audio object before remixing). Different approaches have been developed to efficiently represent the constituent sources present in the mixture. As illustrated in an encoding/decoding framework in FIG. 1, at the encoder (110), both the constituent sources and the mixture are known, and side information about the sources is included into a bitstream together with the encoded audio mixture. At the decoder (120), the mixture and the side information are decoded from the bitstream, and then processed to recover the constituent sources.

Both spatial audio object coding (SAOC) and informed source separation (ISS) techniques can be used to recover the constituent sources. In particular, spatial audio object coding aims at recovering audio objects (e.g., voices, instruments or ambience, music signal includes several objects such as guitar object, piano object) at the decoding side given the transmitted mixture and side information about the encoded audio objects. The side information can be the inter- and intra-channel correlation or source localization parameters.

On the other hand, an informed source separation approach assumes that the original sources are available during the encoding stage, and aim to recover audio sources from a given mixture. During the decoding stage, both the mixture and side information are processed to recover the sources.

An exemplary ISS workflow is shown in FIG. 2. At the encoding side, given the original sources s and the mixture x, source model parameter \hat{θ} is estimated (210), for example, using nonnegative matrix factorization (NMF). The model parameter is quantized and encoded, and then transmitted as side information (220). At the decoding side, the model parameter is reconstructed as θ̅ (230) and the mixture x is decoded. The sources are reconstructed as ŝ given the source model, parameter θ̅, and the mixture x (240) (e.g., by Wiener filtering and residual coding).

### SUMMARY

According to a general aspect, a method of audio encoding is presented, comprising: accessing an audio mixture associated with an audio source; determining an index of a non-zero group of a time activation matrix for the audio source, the group corresponding to one or more rows of the time activation matrix, the time activation matrix being determined based on the audio source and a universal spectral model; encoding the index of the non-zero group and the audio mixture into a bitstream; and providing the bitstream as output.

The method of audio encoding may further provide coefficients of the non-zero group of the time activation matrix as the output.

The method of audio encoding may determine the time activation matrix based on factorizing a spectrogram of the audio source, given the universal spectral model, by nonnegative matrix factorization with a sparsity constraint.

The present embodiments also provide an apparatus for audio encoding, comprising a memory and one or more processors configured to perform any of the methods described above.

Notably, according to some embodiments, the apparatus for audio encoding is configured for:

accessing an audio mixture associated with an audio source;
encoding, into a bitstream, the audio mixture and an index of a non-zero group of a time activation matrix for the audio source, the group corresponding to one or more rows of the time activation matrix, the time activation matrix being determined based on the audio source and a universal spectral model; and
providing the bitstream as output.

According to another general aspect, a method of audio decoding is presented, comprising: accessing an audio mixture associated with an audio source; accessing an index of a non-zero group of a time activation matrix for the audio source, the group corresponding to one or more rows of the time activation matrix; accessing coefficients of the non-zero group of the time activation matrix of the audio source; and reconstructing the audio source based on the coefficients of the non-zero group of the time activation matrix and the audio mixture.

The method of audio decoding may reconstruct the audio source based on a universal spectral model.

The method of audio decoding may decode the coefficients of the non-zero group of the time activation matrix from a bitstream.

The method of audio decoding may set coefficients of another group of the time activation matrix to zero.

The method of audio decoding may determine the coefficients of the non-zero group of the time activation matrix based on the audio mixture, the index of the non-zero group of the time activation matrix, and the universal spectral model.

The audio mixture may be associated with a plurality of audio sources, wherein a second time activation matrix is determined based on the audio mixture, the indices of non-zero groups of time activation matrices of the plurality of audio sources, and the universal spectral model. Coefficients of a group of the second time activation matrix may be set to zero if the group is indicated as zero by each one of the plurality of the audio sources, and the coefficients of the non-zero group of the time activation matrix may be determined from the second time activation matrix. The coefficients of the non-zero group of the time activation matrix may be set to coefficients of a corresponding group of the second time activation matrix. Further, the coefficients of the non-zero group of the time activation matrix may be determined based on a number of sources indicating that the group is non-zero.

The present embodiments also provide an apparatus for audio decoding, comprising a memory and one or more processors configured to perform any of the methods described above.

Notably, according to some embodiments, the apparatus for audio decoding is configured for accessing an audio mixture associated with an audio source; accessing an index of a non-zero group of a time activation matrix for the audio source, the group corresponding to one or more rows of the time activation matrix; accessing coefficients of the non-zero group of the time activation matrix of the audio source; and reconstructing the audio source based on the coefficients of the non-zero group of the time activation matrix and the audio mixture.

The present embodiments also provide a non-transitory program storage device, readable by a computer.

According to an embodiment of the present disclosure, the non-transitory computer readable storage device tangibly embodies a program of instructions executable by a computer to perform the encoding or the decoding method of the present disclosure in any of its embodiments.

Notably, according to some embodiments, the non-transitory computer readable storage device tangibly embodies a program of instructions executable by a computer to perform a method of audio encoding comprising:

accessing an audio mixture associated with an audio source;
encoding, into a bitstream, the audio mixture and an index of a non-zero group of a time activation matrix for the audio source, the group corresponding to one or more rows of the time activation matrix, the time activation matrix being determined based on the audio source and a universal spectral model; and
providing the bitstream as output.

Notably, according to some embodiments, the non-transitory computer readable storage device tangibly embodies a program of instructions executable by a computer to perform a method of audio decoding, the method comprising:

accessing an audio mixture associated with an audio source;
accessing an index of a non-zero group of a first time activation matrix for the audio source, the group corresponding to one or more rows of the first time activation matrix;
accessing coefficients of the non-zero group of the time activation matrix of the audio source; and
reconstructing the audio source based on the coefficients of the non-zero group of the first time activation matrix and the audio mixture.

The present embodiments also provide a non-transitory computer readable storage medium having stored thereon instructions for performing any of the methods described above.

Notably, according to some embodiments, the non-transitory computer readable storage medium has stored thereon instructions for performing a method of audio encoding comprising: accessing an audio mixture associated with an audio source;

encoding, into a bitstream, the audio mixture and an index of a non-zero group of a time activation matrix for the audio source, the group corresponding to one or more rows of the time activation matrix, the time activation matrix being determined based on the audio source and a universal spectral model; and
providing the bitstream as output.

Notably, according to other embodiments, the non-transitory computer readable storage medium has stored thereon instructions for performing a method of audio decoding, the method comprising:

accessing an audio mixture associated with an audio source;
accessing an index of a non-zero group of a first time activation matrix for the audio source, the group corresponding to one or more rows of the first time activation matrix;
accessing coefficients of the non-zero group of the time activation matrix of the audio source; and
reconstructing the audio source based on the coefficients of the non-zero group of the first time activation matrix and the audio mixture.

The present embodiments also provide a non-transitory computer readable program product comprising program code instructions for performing, when said non-transitory software program is executed by a computer, any of the methods described above.

Notably, the present embodiments provide a non-transitory computer readable program product comprising program code instructions for performing, when said non-transitory software program is executed by a computer, a method of audio encoding comprising:

accessing (810) an audio mixture associated with an audio source;
encoding (840), into a bitstream, the audio mixture and an index of a non-zero group of a time activation matrix for the audio source, the group corresponding to one or more rows of the time activation matrix, the time activation matrix being determined based on the audio source and a universal spectral model; and
providing (870) the bitstream as output.

The present embodiments also provide a non-transitory computer readable program product comprising program code instructions for performing, when said non-transitory software program is executed by a computer, a method of audio decoding, the method comprising:

accessing (1220) an audio mixture associated with an audio source;
accessing (1220) an index of a non-zero group of a first time activation matrix for the audio source, the group corresponding to one or more rows of the first time activation matrix;
accessing (1240) coefficients of the non-zero group of the time activation matrix of the audio source; and
reconstructing (1250) the audio source based on the coefficients of the non-zero group of the first time activation matrix and the audio mixture.

### BRIEF DESCRIPTION OF THE DRAWINGS

FIG. 1 illustrates an exemplary framework for encoding an audio mixture and recovering constituent audio sources from the mixture.

FIG. 2 illustrates an exemplary informed source separation workflow.

FIG. 3 depicts a block diagram of an exemplary system where informed source separation techniques can be used, according to an embodiment of the present principles.

FIG. 4 provides an exemplary illustration to generate a universal spectral model.

FIG. 5 illustrates an exemplary method for estimating the source model parameters, according to an embodiment of the present principles.

FIG. 6 illustrates one example of the estimated time activation matrix using block sparsity constraints (each block corresponding to one audio example), where several blocks of the time activation matrix is activated.

FIG. 7 illustrates one example of the time estimated activation matrix using component sparsity constraints, where several components of the time activation matrix are activated.

FIG. 8 illustrates an exemplary method for generating a bitstream, according to an embodiment of the present principles.

FIG. 9 depicts a block diagram of an exemplary system for recovering audio sources, according to an embodiment of the present principles.

FIG. 10 illustrates an exemplary method for recovering constituent sources when the coefficients of activation matrices are not transmitted, according to an embodiment of the present principles.

FIG. 11A is a pictorial example illustrating recovering time activation matrix Hⱼ from an estimated matrix H, according to an embodiment of the present principles; and FIG. 11B is another pictorial example illustrating recovering time activation matrix Hⱼ from an estimated matrix H, according to another embodiment of the present principles.

FIG. 12 illustrates an exemplary method for recovering constituent sources from an audio mixture, according to an embodiment of the present principles.

FIG. 13 illustrates a block diagram depicting an exemplary system in which various aspects of the exemplary embodiments of the present principles may be implemented.

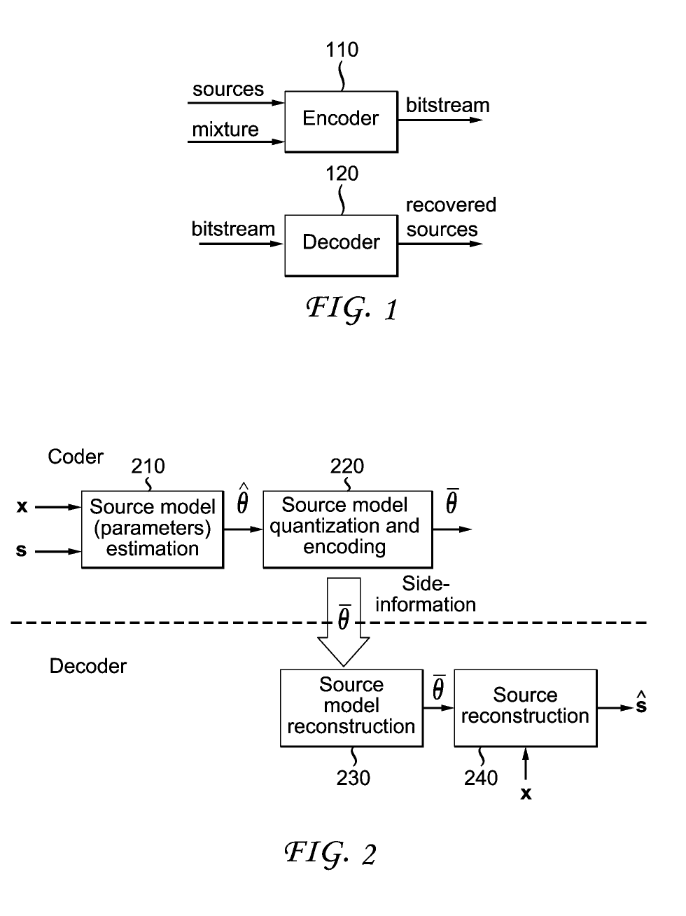

### DETAILED DESCRIPTION

In the present application, we also refer to an audio object as an audio source. When multiple audio sources are mixed, they become an audio mixture. In a simplified example, if the sound waveform from a piano is denoted as s₁, and the speech from a person is denoted as s₂, an audio mixture associated with audio sources s₁ and s₂ can be represented as x=s₁+s₂. To enable a receiver to recover constituent sources s₁ and s₂, a straightforward method is to encode source s₁ and source s₂, and transmit them to the receiver. Alternatively, to reduce the bitrate, mixture x and side information about sources s₁ and s₂ can be transmitted to the receiver.

The present principles are directed to audio encoding and decoding. In one embodiment, at both the encoding and decoding sides, we use a universal spectral model (USM) learned from various audio examples. A universal model is a “generic” model, where the model is redundant (i.e., an overcomplete dictionary) such that in the model fitting step, one needs to select the most representative parts of the model, usually under a sparsity constraint.

The USM can be generated based on nonnegative matrix factorization (NMF), and the indices of the USM characterizing the audio sources rather than the whole NMF model can be encoded as the side information. Consequently, the amount of side information may be very small compared with encoding constituent audio sources directly, and the proposed method may be functional at a very low bit rate.

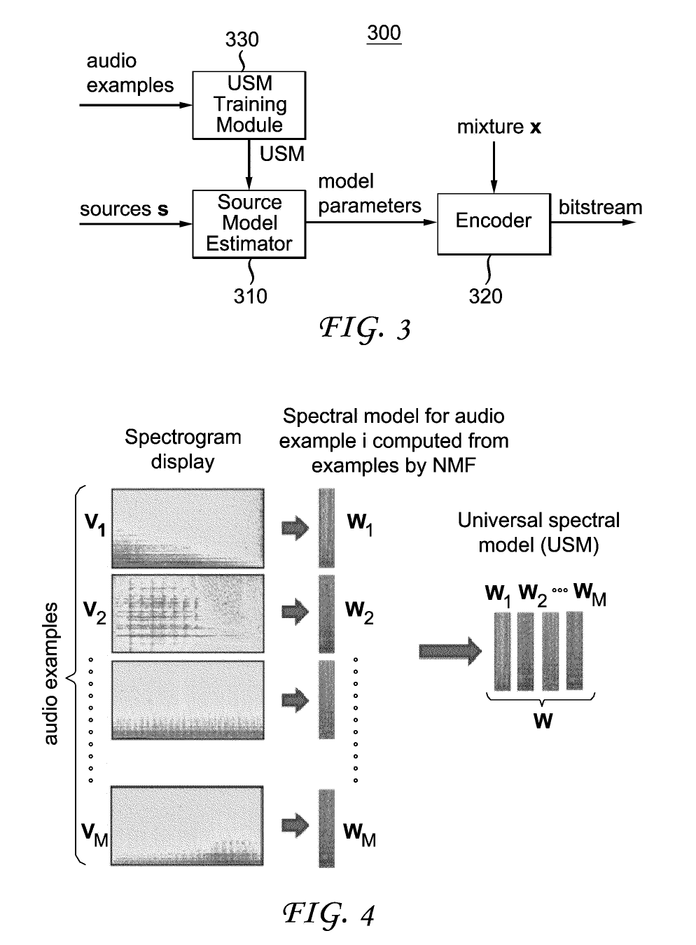

FIG. 3 depicts a block diagram of an exemplary system 300 where informed source separation techniques can be used, according to an embodiment of the present principles. Based on various audio examples, USM training module 330 learns a USM model. The audio examples can come from, for example, but not limited to, a microphone recording in a studio, audio files retieved from the Internet, a speech database, and an automatic speech synthesizer. The USM training may be performed offline, and the USM training module may be separate from other modules.

The source model estimator (310) estimates source model parameters, for example, the active indices of the USM, for representing sources s in the mixture x, based on the USM. The source model parameters are then encoded using an encoder (320) and output as a bitstream containing the side information. Audio mixture x is also encoded into the bitstream. In the following, the USM Training Module (330), the Source Model Estimator (310), and Encoder (320) will be described in further detail.

USM Training

A USM contains an overcomplete dictionary of spectral characteristics of various audio examples. To train the USM model from the audio examples, audio example m is used to learn spectral model Wₘ, where the number of columns in matrix Wₘ, Kₘ, denotes the number of spectral atoms characterizing the audio example m, and the number of rows in Wₘ is the number of frequency bins. The value of Kₘ can be, for example, 4, 8, 16, 32, or 64. Then the USM model is constructed by concatenating the learned models: W=[W₁ W₂ . . . W_{M}]. Amplitude normalization can be applied to ensure that different audio examples have similar energy level.

FIG. 4 provides an exemplary illustration where the NMF process is applied individually to each audio example (indexed by m) to generate a matrix of spectral patterns Wₘ. For each example m, a spectrogram matrix Vₘ is generated using the short time Fourier transform (STFT) where Vₘ can be magnitude or square magnitude of the STFT coefficients computed from the waveform of the audio signal, and a spectral model Wₘ is then calculated. Example of a detailed NMF process (i.e., IS-NMF/MU, where IS refers to Itakura Saito divergence, and MU refers to multiplicative update) to compute the spectral model Wₘ given the spectrogram Vₘ is shown in Table 1, where Hₘ is a time activation matrix. In general, Wₘ and Hₘ can be interpreted as the latent spectral features and the activations of those features in an audio example, respectively. The NMF implementation as shown in Table 1 is an iterative process and nᵢₜₑᵣ is the number of iterations.

TABLE 1
Example of NMF process for learning spectral model
from an audio example

```
Input: Spectrogram matrix Vₘ
Output: Spectral model Wₘ
  Initialize matrix Wₘ and Hₘ randomly with non-negative entries
  for i = 1: nᵢₜₑᵣ do
    ${H}_{m} ← {H}_{m} ⊙ \frac{{W}_{m}^{T} ( ( {W}_{m} {H}_{m} ) {\cdot }^{- 2} ⊙ {V}_{m} )}{{W}_{m}^{T} ( {W}_{m} {H}_{m} ) {\cdot }^{- 1}}$
    ${W}_{m} ← {W}_{m} ⊙ \frac{( ( {W}_{m} {H}_{m} ) {\cdot }^{- 2} ⊙ {V}_{m} ) {H}_{m}^{T}}{( {W}_{m} {H}_{m} ) {\cdot }^{- 1} {H}_{m}^{T}}$
    Normalize Wₘ and Hₘ
  end for
```

Then matrices Wₘ are concatenated to form a large matrix W, which forms a USM model:

W=[W₁,W₂, . . . ,W_{M}]. (1)

Typically, M can be 50, 100, 200 and more so that it covers a wide range of audio examples. In some specific use case where the type of audio sources is known (e.g., for speech coding the audio source is speech), then the number of examples, M, can be much smaller (e.g., M=5, 10) since there is no need to cover other types of audio sources.

The USM model is used to encode and decode all constituent sources. Usually a large spectral dictionary would be learned from a wide range of audio examples to make sure that characteristics of a specific source can be covered by the USM model. In one example, we can use 10 examples for speech, 100 examples for different musical instruments, and 20 examples for different types of environmental sounds, then overall we have M=10+100+20=130 examples for the USM model.

The USM model, which represents characteristics of many different types of sound sources, is assumed to be available at both the encoding and decoding sides. In case the USM model is transmitted, the bit rate may increase a lot since the USM can be very big.

Source Model Estimation

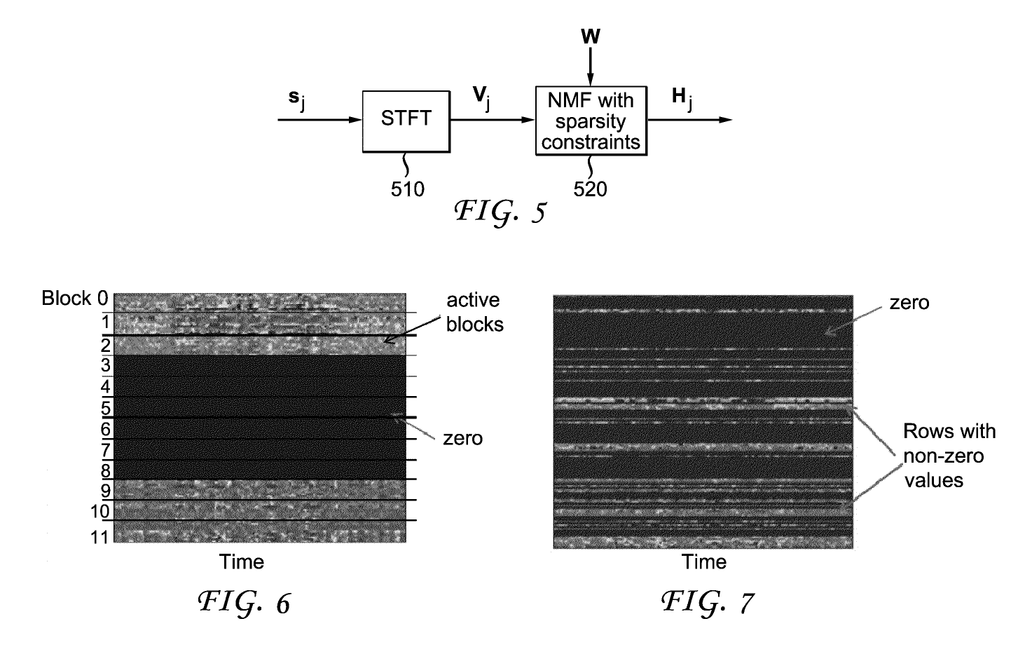

FIG. 5 illustrates an exemplary method 500 for estimating the source model parameters, according to an embodiment of the present principles. For an original source to be encoded, sⱼ, an F×N spectrogram Vⱼ can be computed via the short time Fourier transform (STFT) (510), where F denotes the total number of frequency bins and N denotes the number of time frames.

Using the spectrogram Vⱼ and the USM W, the time activation matrix Hⱼ can be computed (520), for example, using NMF with sparsity constraints. In one embodiment, we consider sparsity constraints on the activation matrix Hⱼ. Mathematically, the activation matrix can be estimated by solving the following optimization problem that includes a divergence function and a sparsity penalty function:

$${min}_{{H}_{j} \geq 0} D ( {V}_{j} \vert {WH}_{j} ) + λ Ψ ( {H}_{j} ) \qquad ( 2 )$$

where D(Vⱼ|WHⱼ)=Σf₌₁^{F}Σₙ₌₁^{N}d(v_{j,fn}|[WHⱼ]_{fn}), f indexes the frequency bin, n indexes the time frame, v_{j,fn} indicates an element in the f-th row and n-th column of the spectrogram of Vⱼ, [WHⱼ]_{fn} is an element in the f-th row and n-th column of the matrix WHⱼ, d(.|.) is a divergence function, and λ is a weighting factor for the penalty function Ψ(.) and controls how much we want to emphasize sparsity of Hⱼ during optimization. Possible divergence functions include, for example, the Itakura-Saito divergence (IS divergence), Euclidean distance, and Kullback-Leibler divergence.

Using a penalty function in the optimization problem is motivated by the fact that if some of the audio examples used to train the USM model are more representative of the audio source contained in the mixture than others, then it may be better to use only these more representative (“good”) examples. Also, some spectral components in the USM model may be more representative for spectral characteristics of the audio source in the mixture, and it may be better to use only these more representative (“good”) spectral components. The purpose of the penalty function is to enforce the activation of “good” examples or components, and force the activations corresponding to other examples and/or components to zero.

Consequently, the penalty function results in a sparse matrix Hⱼ where some groups in Hⱼ are set to zero. In the present application, we use the concept of a group to generalize the subset of elements in the source model which are affected by the sparsity constraint. For example, when the sparsity constraint is applied on a block basis, a group corresponds to a block (a consecutive number of rows) in the matrix Hⱼ which in turn corresponds to activations of one audio example used to train the USM model. When the sparsity constraint is applied on a spectral component basis, a group corresponds to a row in the matrix Hⱼ which in turn corresponds to the activation of one spectral component (a column in W) in the USM model. In another embodiment, a group can be a column in Hⱼ which corresponds to the activation of one frame (audio window) in the input spectrogram. In another embodiment, groups can contain several overlapping rows (i.e., overlapping groups).

Different penalty functions can be used. For example, we can apply the log/l₁ norm (i.e.,

Ψ(Hⱼ)=Σ_{g} log(∈+∥H_{j,(g)}∥₁)), (3)

where H_{j,(g)} is part of the activation matrix Hⱼ corresponding to g-th group. Table 2 illustrates an exemplary implementation to solve the optimization problem using an iterative process with multiplicative updates, where H_{j,(g)} represents a block (sub-matrix) of Hⱼ, h_{j,k} represents a component (row) of Hⱼ, ⊙ denotes the element-wise Hadamard product, G is the number of blocks in Hⱼ, K is the number of rows in Hⱼ, and ∈ is a constant. In Table 2, Hⱼ is initialized randomly. In other embodiments, it can be initialized in other manners.

TABLE 2
Example of NMF process with sparsity-inducing constraints for
estimating the time activation matrix of each source at the
encoding side

```
Input: Vⱼ, W, λ
Output: Hⱼ
  Initiallize Hⱼ randomly with nonnegative entries
  \hat{V}ⱼ = WHⱼ
  repeat
    if Block sparsitv-inducing penalty then
      for g = 1, . . . , G do
        ${P}_{( g )} ← \frac{1}{ϵ + {‖ {H}_{j , ( g )} ‖}_{1}}$
      end for
      P = [P₍₁₎^{T}, . . . , P_{(G)}^{T}]^{T}
    end if
    if Component sparsity-inducing penalty then
      for k = 1, . . . , K do
        ${p}_{k} ← \frac{1}{ϵ + ‖ {h}_{j , k} ‖}$
      end for
      P = [p₁^{T}, . . . , p_{K}^{T}]^{T}
    end if
    ${H}_{j} ← {H}_{j} ⊙ {( \frac{{W}^{T} ( {V}_{j} ⊙ {\hat{ V}}_{j}^{\cdot - 2} )}{{W}^{T} ( {\hat{V}}_{j}^{\cdot - 1} ) + λ P} )}^{\cdot \frac{1}{2}}$
    \hat{V}ⱼ ← WHⱼ
  until convergence
```

In another embodiment, we may use a relative block sparsity approach instead of the penalty function shown in Eq. (3), where a block represents activations corresponding to one audio example used to train the USM model. This may efficiently select the best audio examples or spectral components in W to represent the audio source in the mixture. Mathematically, the penalty function may be written as:

$${Ψ}_{1} ( {H}_{j} ) = {\sum }_{g = 1}^{G} log ( ϵ + \frac{{‖ {H}_{j , ( g )} ‖}_{q}}{{‖ {H}_{j} ‖}_{p}^{γ}} ) \qquad ( 4 )$$

where G denotes the number of blocks (i.e., corresponding to the number of audio examples used for training the universal model), ∈ is a small value greater than zero to avoid having log(0), H_{j,(g)} is part of the activation matrix Hⱼ corresponding to g-th training example, p and q determine the norm or pseudo-norm to be used (for example, p=q=1), and γ is a constant (for example, 1 or 1/G). The ∥Hⱼ∥ₚ norm is calculated over all the elements in Hⱼ as (Σ_{k,n}|h_{j,k,n}|^{p})^{1p}.

FIG. 6 illustrates one example of the estimated time activation matrix Hⱼ using block sparsity constraints or relative block sparsity constraint (each block corresponding to one audio example), where only blocks 0-2 and blocks 9-11 of Hⱼ are activated (i.e., audio source j will be represented by several audio examples from the USM model). The index of any block with a non-zero coefficient in Hⱼ is encoded as side information for the original source j. In the example of FIG. 6, block indices 0-2 and 9-11 are indicated in the side information.

In another embodiment, we can also use a relative component sparsity approach to allow more flexibility and choose the best spectral components. Mathematically, the penalty function may be written as:

$${Ψ}_{2} ( {H}_{j} ) = {\sum }_{g = 1}^{K} log ( ϵ + \frac{{‖ {h}_{j , ( g )} ‖}_{q}}{{‖ {H}_{j} ‖}_{p}^{γ}} ) \qquad ( 5 )$$

where h_{j,g} is g-th row in Hⱼ, and K is the number of rows in Hⱼ. Note that each row in Hⱼ represents the activation coefficients for the corresponding column (the spectral component) in W. For example, if the first row of Hⱼ is zero, then the first column of W is not used to represent Vⱼ (where Vⱼ=WHⱼ). FIG. 7 illustrates one example of the estimated time activation matrix Hⱼ using component sparsity constraints, where several components of Hⱼ are activated. The index of any row with non-zero coefficients in Hⱼ is encoded as side information for the original source j.

In another embodiment, we can use a mix of block and component sparsity. Mathematically, the penalty function can be written as:

Ψ₃(Hⱼ)=αΨ₁(Hⱼ)+βΨ₂(Hⱼ) (6)

where α and β are weights determining the contribution of each penalty.

In another embodiment, the penalty function Ψ(Hⱼ) can take another form, for example, we can propose another relative group sparsity approach to choose the best spectral characteristics:

$${Ψ}_{4} ( {H}_{j} ) = {\sum }_{g = 1}^{G} log ( \frac{ϵ + {‖ {H}_{j , ( g )} ‖}_{q}}{{‖ {H}_{j} ‖}_{p}^{γ}} ) \qquad ( 7 )$$

where H_{j,(g)} is g-th group in Hⱼ. Similarly, penalty functions Ψ₂ (Hⱼ) and Ψ₃(Hⱼ) can also be adjusted.

In addition, the performance of the penalty function may depend on the choice of the λ value. If λ is small, Hⱼ usually does not become zero but may include some “bad” groups to represent the audio mixture, which affects the final separation quality. However, if λ gets larger, the penalty function cannot guarantee that Hⱼ will not become zero. In order to obtain a good separation quality, the choice of λ may need to be adaptive to the input mixture. For example, the longer the duration of the input (large N), the bigger λ may need to be to result in a sparse Hⱼ since Hⱼ is now correspondingly large (size K×N).

Encoding

Based on the sparsity constraint that is used in the penalty function, different strategies can be used for choosing side information. Here, for ease of notation, we denote block indices by b and component indices by k.

Strategy a (for Component Sparsity):

When a component sparsity constraint is used in the penalty function, the indices {k} of the non-zero rows of the matrix Hⱼ corresponding to source j are encoded as the side information, which can be very small compared with encoding individual sources directly.

Strategy B (for Block Sparsity):

When a block sparsity constraint is used in the penalty function, the indices {b} of the representative examples (i.e., with non-zero coefficients in activation matrix Hⱼ) can be encoded as the side information. The side information would be even smaller than that is generated by Strategy A, where a component sparsity constraint is used.

Strategy C (for Combination of Block and Component Sparsity):

When both the block sparsity and component sparsity constraints are used in the penalty function, the indices {b} of the non-zero bocks, and corresponding indices {k} of the non-zero rows for each non-zero block can be encoded as the side information.

In one embodiment, the non-zero coefficients of matrices Hⱼ are transmitted as well as the non-zero indices. Alternatively, the coefficients of matrices Hⱼ are not transmitted, and at the decoding side the activation matrices Hⱼ are estimated to reconstruct the sources. The side information sent can be in the form:

[(source 1,θ₁), . . . ,(source J,θ_{J})], (8)

where θᵢ represents the model parameters, for example, the non-zero indices (and the coefficients of matrices Hⱼ) corresponding to source j. To further reduce the bitrate needed for side information transmission, the model parameters may be encoded by a lossless coder, e.g., Huffman coder.

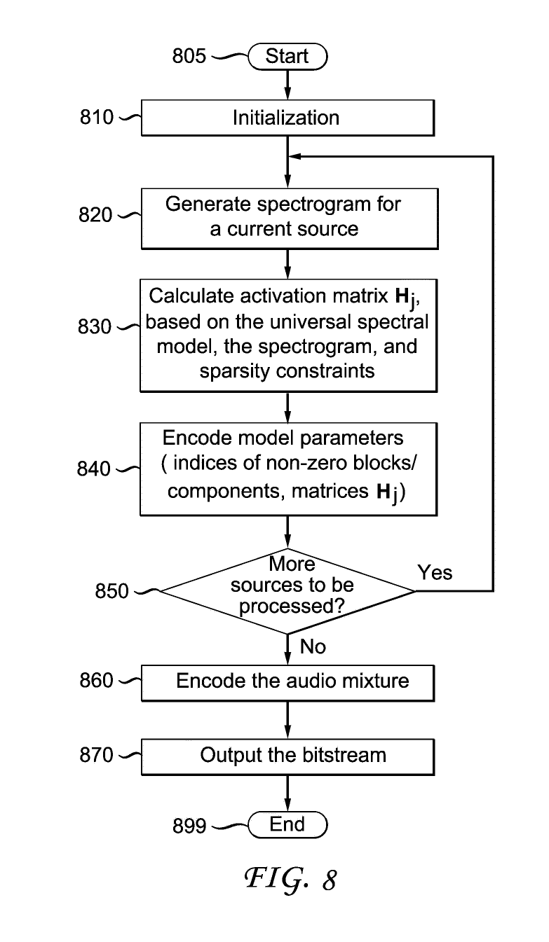

FIG. 8 illustrates an exemplary method 800 for generating an audio bitstream, according to an embodiment of the present principles. Method 800 starts at step 805. At step 810, initialization of the method is performed, for example, to choose which strategy is to be used, access USM W, input original sources s={sⱼ}_{j=1, . . . , J} and the mixture x, the divergence function and the sparsity constraint function used to obtain the activation matrix Hⱼ. At step 820, for a current source sⱼ, a spectrogram is generated as Vⱼ. Using the USM model, the divergence function and sparsity constraints, an activation matrix Hⱼ can be calculated at step 830 for source sⱼ, for example, as a solution to the minimization problem of Eq. (2). At step 840, the model parameters, for example, the indices of non-zero blocks/components in the activation matrix, and the non-zero block/components of activation matrices may be encoded.

At step 850, the encoder checks whether there are more audio sources to process. It should be noted that we might generate source model parameters only for the audio sources that need to be recovered, rather than all constituent sources included in the mixture. For example, for a karaoke signal, we may choose to only recover the music, but not the voice. If there are more sources to be processed, the control returns to step 820. Otherwise, the audio mixture is encoded at step 860, for example, using MPEG-1 Layer 3 (i.e., MP3) or Advanced Audio Coding (AAC). The encoded information is output in a bitstream at step 870. Method 800 ends at step 899.

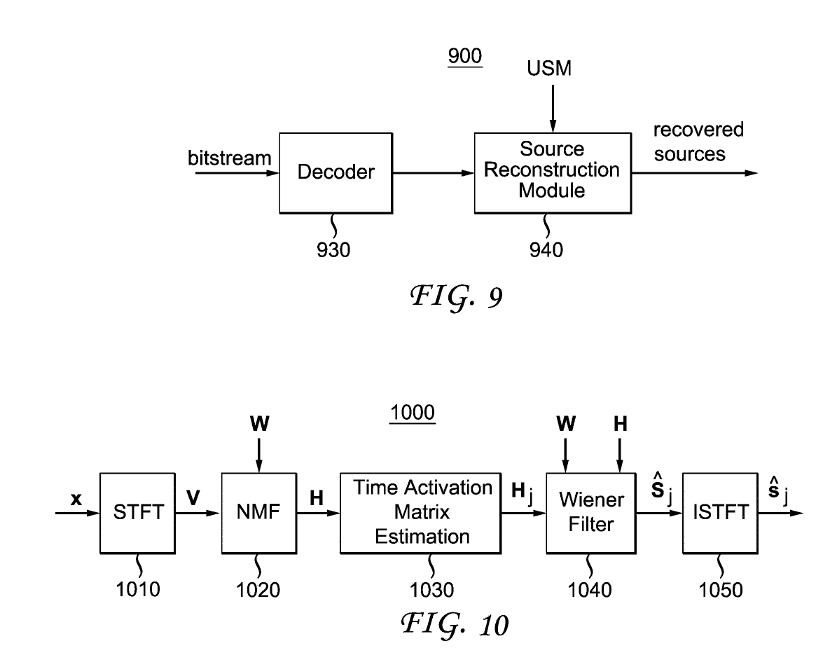

FIG. 9 depicts a block diagram of an exemplary system 900 for recovering audio sources, according to an embodiment of the present principles. From an input bitstream, a decoder (930) decodes the audio mixture and decodes the source model parameters used to indicate the audio source information. Based on a USM model and the decoded source model parameters, the source reconstruction module (940) recovers the constituent sources from the mixture x. In the following, the source reconstruction module (940) will be described in further detail.

Source Reconstruction

When the non-zero coefficients of activation matrices Hⱼ are included in the bitstream, the activation matrices can be decoded from the bitstream. The full matrix Hⱼ is recovered by placing zero at the remaining blocks/rows in the F-by-N matrix (the size of this matrix is known a priori). Then a matrix H can be computed directly from Hⱼ, for example, as:

H=ΣⱼHⱼ. (9)

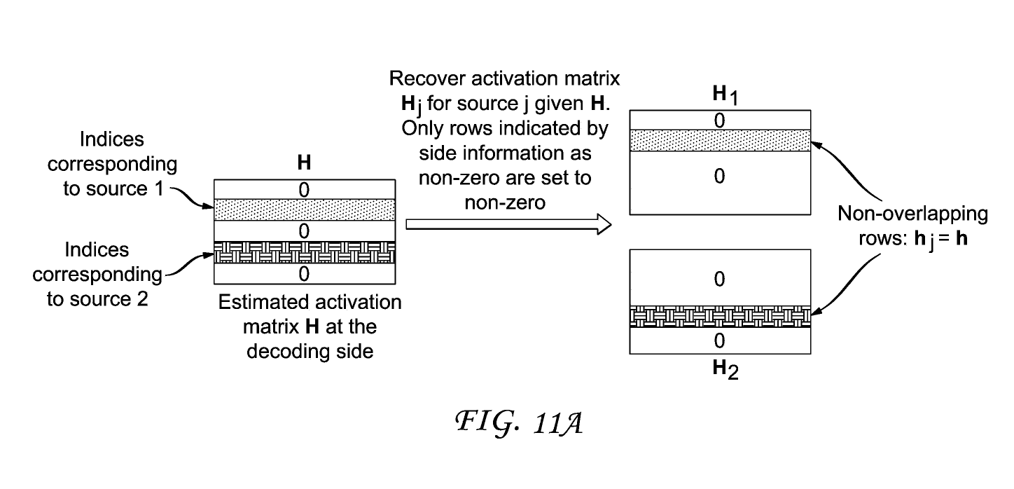

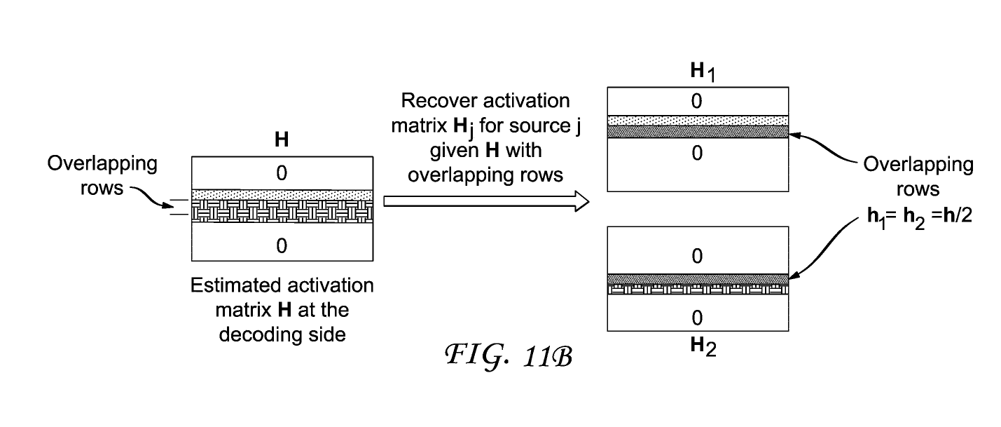

Alternatively, when the coefficients of activation matrices Hⱼ are not included in the bitstream, the activation matrices can be estimated from the mixture x, the USM model, and the source model parameters. FIG. 10 illustrates an exemplary method 1000 for recovering constituent sources when the coefficients of activation matrices are not transmitted, according to an embodiment of the present principles.

An input spectrogram matrix V is computed from the mixture signal x received at the decoding side (1010), for example, using STFT, and the USM model W is also available at the decoding side. An NMF process is used at the decoding side to estimate the time activation matrix H (1020), which contains all activation information for all sources (note that H and Hⱼ are matrices with the same size). When initializing H, a row in matrix H is initialized as non-zero coefficients if any source model parameters (e.g., decoded non-zero indices of blocks/components) indicate that row as non-zero. Otherwise, a row of H is initialized as zero and the coefficients always remain zero.

Table 3 illustrates an exemplary implementation to solve the optimization problem using an iterative process with multiplicative updates. It should be noted that the implementations shown in Table 1, Table 2 and Table 3 are NMF processes with IS divergence and without other constraint, and other variants of NMF processes can be applied.

TABLE 3
Example of NMF process for estimating the time activation
matrix at the decoding when the coefficients of non-zero
blocks/components are not transmitted

```
Input: Spectrogram matrix of the mixture signal V, USM model W
Output: Time activation matrix H
  Initialize matrix H
  for i = 1: nᵢₜₑᵣ do
    $H ← H ⊙ \frac{{W}^{T} ( ( WH ) {\cdot }^{- 2} ⊙ V )}{{W}^{T} ( WH ) {\cdot }^{- 1}}$
  end for
```

Once H is estimated, the corresponding activation matrices for each source j, Hⱼ, can be computed from H, at step 1030, for example, as shown in FIG. 11A. For a row without overlap between sources, namely, when the row is indicated as non-zero by an index of only one source, the coefficients of the non-zero rows in Hⱼ as indicated by decoded source parameters are set to the value of corresponding rows in matrix H, and other rows are set to zero. If a row of H corresponds to several sources, namely, the row is indicated as non-zero by decoded non-zero indices of more than one sources, the corresponding coefficients of non-zero rows in Hⱼ can be computed by dividing the corresponding coefficients of rows in H by the number of overlapping sources, as shown in FIG. 11B.

Referring back to FIG. 10, given the USM model W and the activation matrices Hⱼ, the matrix of the STFT coefficients for source j can be estimated by the standard Wiener filtering (1040) as

$${\hat{S}}_{j} = \frac{{WH}_{j}}{WH} \cdot X \qquad ( 10 )$$

where X is the F-by-N matrix of the STFT coefficients of the mixture signal x, and “·” denotes the piecewise multiplication. Source signal in the time domain ŝⱼ can then be recovered (1050) from the STFT coefficients Ŝⱼ, using inverse STFT (ISTFT).

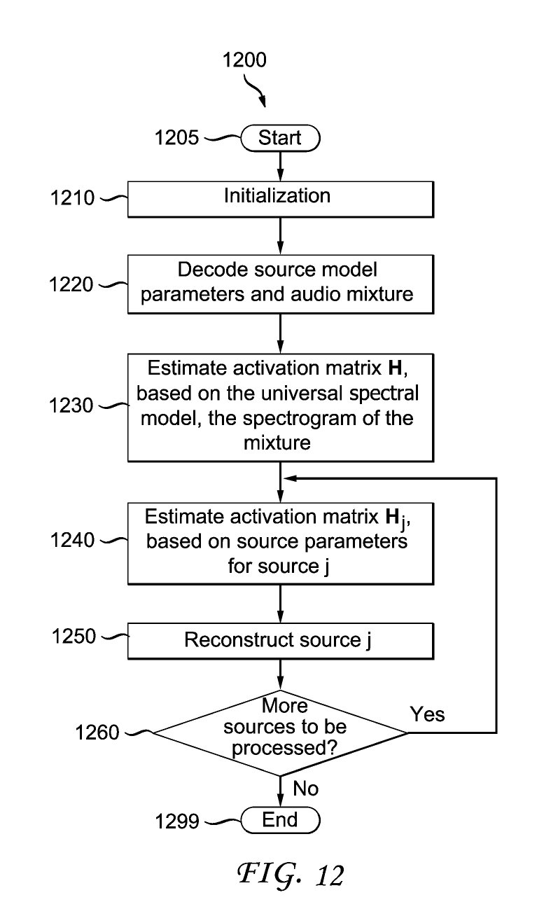

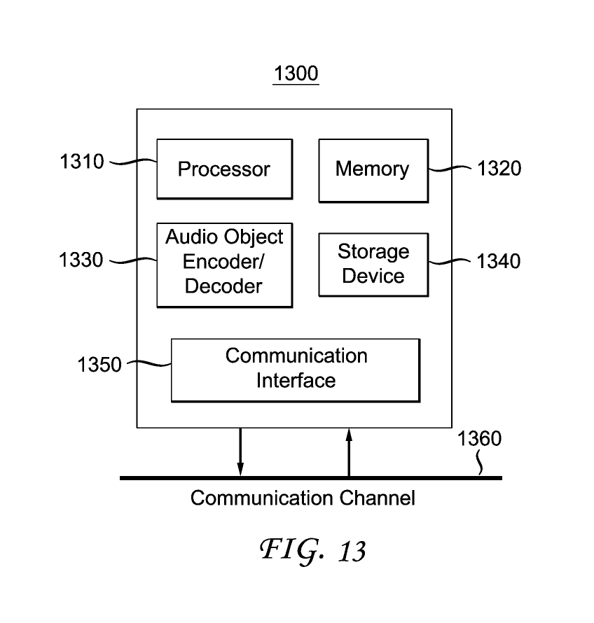

FIG. 12 illustrates an exemplary method 1200 for recovering the constituents sources from an audio mixture, according to an embodiment of the present principles. Method 1200 starts at step 1205. At step 1210, initialization of the method is performed, for example, to choose which strategy is to be used, access the USM model W, and input the bitstream. At step 1220, the side information is decoded to generate the source model parameters, for example, the non-zero indices of blocks/components. The audio mixture is also decoded rom the bitstream. Using the USM model and the source model parameters, an overall activation matrix H can be calculated at step 1230, for example, applying NMF to the spectrogram of mixture x and setting some rows of the matrix to zero based on the non-zero indices. The activation matrix for an individual source sⱼ can be estimated from the overall matrix H and the source parameters for source j, at step 1240, for example, as illustrated in FIGS. 11A and 11B. At step 1250, source j can be reconstructed from activation matrix Hⱼ for source j, the USM model, the mixture, and the overall matrix H, for example, using Eq. (10) followed by an ISTFT. At step 1260, the decoder checks whether there are more audio sources to process. If yes, the control returns to step 1240. Otherwise, method 1200 ends at step 1299.

If the activation matrices Hⱼ are indicated in the bitstream, steps 1230 and 1240 can be omitted.

FIG. 13 illustrates a block diagram of an exemplary system 1300 in which various aspects of the exemplary embodiments of the present principles may be implemented. System 1300 may be embodied as a device including the various components described below and is configured to perform the processes described above. Examples of such devices, include, but are not limited to, personal computers, laptop computers, smartphones, tablet computers, digital multimedia set top boxes, digital television receivers, personal video recording systems, connected home appliances, and servers. System 1300 may be communicatively coupled to other similar systems, and to a display via a communication channel as shown in FIG. 13 and as known by those skilled in the art to implement the exemplary video system described above.

The system 1300 may include at least one processor 1310 configured to execute instructions loaded therein for implementing the various processes as discussed above. Processor 1310 may include embedded memory, input output interface and various other circuitries as known in the art. The system 1300 may also include at least one memory 1320 (e.g., a volatile memory device, a non-volatile memory device). System 1300 may additionally include a storage device 1340, which may include non-volatile memory, including, but not limited to, EEPROM, ROM, PROM, RAM, DRAM, SRAM, flash, magnetic disk drive, and/or optical disk drive. The storage device 1340 may comprise an internal storage device, an attached storage device and/or a network accessible storage device, as non-limiting examples. System 1300 may also include an audio encoder/decoder module 1330 configured to process data to provide an encoded bitstream or reconstructed constituent audio sources.

Audio encoder/decoder module 1330 represents the module(s) that may be included in a device to perform the encoding and/or decoding functions. As is known, a device may include one or both of the encoding and decoding modules. Additionally, audio encoder/decoder module 1330 may be implemented as a separate element of system 1300 or may be incorporated within processors 1310 as a combination of hardware and software as known to those skilled in the art.

Program code to be loaded onto processors 1310 to perform the various processes described hereinabove may be stored in storage device 1340 and subsequently loaded onto memory 1320 for execution by processors 1310. In accordance with the exemplary embodiments of the present principles, one or more of the processor(s) 1310, memory 1320, storage device 1340 and audio encoder/decoder module 1330 may store one or more of the various items during the performance of the processes discussed herein above, including, but not limited to the audio mixture, the USM model, the audio examples, the audio sources, the reconstructed audio sources, the bitstream, equations, formula, matrices, variables, operations, and operational logic.

The system 1300 may also include communication interface 1350 that enables communication with other devices via communication channel 1360. The communication interface 1350 may include, but is not limited to a transceiver configured to transmit and receive data from communication channel 1360. The communication interface may include, but is not limited to, a modem or network card and the communication channel may be implemented within a wired and/or wireless medium. The various components of system 1300 may be connected or communicatively coupled together using various suitable connections, including, but not limited to internal buses, wires, and printed circuit boards.

The exemplary embodiments according to the present principles may be carried out by computer software implemented by the processor 1310 or by hardware, or by a combination of hardware and software. As a non-limiting example, the exemplary embodiments according to the present principles may be implemented by one or more integrated circuits. The memory 1320 may be of any type appropriate to the technical environment and may be implemented using any appropriate data storage technology, such as optical memory devices, magnetic memory devices, semiconductor-based memory devices, fixed memory and removable memory, as non-limiting examples. The processor 1310 may be of any type appropriate to the technical environment, and may encompass one or more of microprocessors, general purpose computers, special purpose computers and processors based on a multi-core architecture, as non-limiting examples.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation” of the present principles, as well as other variations thereof, mean that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Further, this application or its claims may refer to “accessing” various pieces of information. Accessing the information may include one or more of, for example, receiving the information, retrieving the information (for example, from memory), storing the information, processing the information, transmitting the information, moving the information, copying the information, erasing the information, calculating the information, determining the information, predicting the information, or estimating the information.

Additionally, this application or its claims may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method of audio encoding, comprising:
encoding, into a bitstream, an audio mixture associated with an audio source and an index of a non-zero group of a time activation matrix for the audio source, the group corresponding to one or more rows of the time activation matrix, the time activation matrix being determined based on the audio source and a universal spectral model; and
providing the bitstream as output.

2. The method of claim 1, comprising providing coefficients of the non-zero group of the time activation matrix as the output.

3. A method of audio decoding, comprising:
accessing an index of a non-zero group of a first time activation matrix for an audio source, the group corresponding to one or more rows of the first time activation matrix;
accessing coefficients of the non-zero group of the first time activation matrix of the audio source; and
reconstructing the audio source based on the coefficients of the non-zero group of the first time activation matrix and an audio mixture associated with an audio source.

4. The method of claim 3, wherein the audio source is reconstructed based on a universal spectral model.

5. The method of claim 3, wherein the coefficients of the non-zero group of the first time activation matrix are decoded from a bitstream.

6. The method of claim 3, wherein coefficients of another group of the first time activation matrix are set to zero.

7. The method of claim 3, wherein the coefficients of the non-zero group of the first time activation matrix are determined based on the audio mixture, the index of the non-zero group of the first time activation matrix, and the universal spectral model.

8. The method of claim 7, wherein the audio mixture is associated with a plurality of audio sources, and wherein a second time activation matrix is determined based on the audio mixture, the indices of non-zero groups of first time activation matrices of the plurality of audio sources, and the universal spectral model.

9. The method of claim 8, wherein coefficients of a group of the second time activation matrix are set to zero if the group is indicated as zero by each one of the plurality of the audio sources.

10. The method of claim 8, wherein the coefficients of the non-zero group of the first time activation matrix are determined from the second time activation matrix.

11. The method of claim 10, wherein the coefficients of the non-zero group of the first time activation matrix are set to coefficients of a corresponding group of the second time activation matrix.

12. The method of claim 10, wherein the coefficients of the non-zero group of the first time activation matrix are determined based on a number of sources indicating that the group is non-zero.

13. An apparatus of audio encoding, comprising a memory and one or more processors configured for performing the method of claim 1.

14. An apparatus of audio decoding, comprising a memory and one or more processors configured to perform the method of claim 3.

15. A non-transitory computer readable storage medium having stored thereon instructions for performing a method according to claim 1.

16. A non-transitory computer readable storage medium having stored thereon instructions for performing a method according to claim 3.

17. A non-transitory computer readable program product comprising program code instructions for performing, when said non-transitory software program is executed by a computer, a method according to claim 1.

18. A non-transitory computer readable program product comprising program code instructions for performing, when said non-transitory software program is executed by a computer, a method according to claim 3.

19. A method of audio encoding, comprising:
encoding, into a bitstream, an audio mixture, associated with an audio source, and an index of a non-zero group of a time activation matrix for the audio source, the time activation matrix being determined based on the audio source and a universal spectral model, the non-zero group corresponding to activation coefficients, in the time activation matrix, related to one or more spectral components of the universal spectral model; and
providing the bitstream as output.

20. The method of claim 19, comprising providing coefficients of the non-zero group of the time activation matrix as the output.
